(19) United States
(12) Patent Application Publication
(10) Pub. No.: US 2017/0062162 A1
(43) Pub. Date: Mar. 2, 2017

(54) ELECTRICAL RELAY HAVING ELECTROMAGNETIC, NON-VOLATILE STATE RETENTION

(71) Applicant: R.S.M. Electron Power, Inc., Dear Park, NY (US)

(72) Inventors: Robert James Sichenzia, Sayville, NY (US); Paul Michael Resch, Bethpage, NY (US); Keith Eric Monaghan, Port Jefferson, NY (US)

(21) Appl. No.: 15/094,146

(22) Filed: Apr. 8, 2016

Related U.S. Application Data
(60) Provisional application No. 62/213,279, filed on Sep. 2, 2015.

(51) Int. Cl. H01H 47/22

(52) U.S. Cl. CPC H01H 47/22

(57) ABSTRACT

A relay including an interface circuit, a magnetic core, and an output transistor. The interface circuit includes a plurality of input terminals, a voltage supply terminal, and at least one output terminal. The magnetic core is connected to the interface circuit and configured to form at least one bit of non-volatile core memory. The output transistor includes a plurality of conduction terminals and a control terminal. The control terminal is connected to the output terminal of the interface circuit.

### CROSS REFERENCE TO RELATED APPLICATION

This application claims the benefit under 35 U.S.C. §119(e) of U.S. Provisional Patent Application No. 62/213,279, filed Sep. 2, 2015, and titled “Electrical Relay Having Electromagnetic, Non-Volatile State Retention,” the entirety of which is incorporated herein by reference.

### FIELD OF THE INVENTION

This invention relates to an electrical relay and, in particular, an electrical relay having a memory that is electromagnetic and non-volatile to store the state of the relay.

### BACKGROUND OF THE INVENTION

Relays typically use a relatively low power control signal supplied to a control circuit to open and close a higher power circuit. For example, one conventional solid-state latching relay is model # AP10NP01LL5E1 made by API Technologies Corp. of Orlando, Fla., and another conventional solid-state relay is Series M33-2N made by Teledyne Technologies Inc. of Hawthorne, Calif. These solid-state relays, however, do not have a non-volatile state retention feature. In the event that power is lost to the control circuit of the relay, it is desirable for the control circuit of the relay to have a non-volatile state retention feature. When power is restored, the relay may be returned to its previous state because the non-volatile state retention feature of the control circuit retained the last state (e.g., open or closed) of the relay.

One conventional relay relies on an electromechanical function to provide non-volatile state-retention. U.S. Pat. No. 6,917,500, for example, discloses the use of a combination of a solid-state output circuit with an electromechanical state-retention mechanism. Prior art approaches, which rely on an electromechanical mechanism for either load switching or state-retention, may still be unsuitable for certain applications, such as space and aerospace applications. In these applications, the relay may be exposed to harsh shock and vibration environments where the electromechanical mechanism has been known to be troublesome when non-volatile state retention is required.

### SUMMARY OF THE INVENTION

In one aspect, the invention relates to a relay having a magnetic core. The relay includes an interface circuit, the magnetic core, and an output transistor. The interface circuit includes a plurality of input terminals, a voltage supply terminal, and at least one output terminal. The magnetic core is connected to the interface circuit and configured to form at least one bit of non-volatile core memory. The output transistor includes a plurality of conduction terminals and a control terminal. The control terminal is connected to the output terminal of the interface circuit.

In another aspect, the invention relates to a relay having a solid-state memory. The relay includes an interface circuit, a solid-state memory device, and an output transistor. The interface circuit includes a plurality of input terminals, a voltage supply terminal, and at least one output terminal. The solid-state memory device is connected to the interface circuit and configured to form one bit of non-volatile memory. The output transistor includes a plurality of conduction terminals and a control terminal. The control terminal is connected to the output terminal of the interface circuit.

In a further aspect, the invention relates to an electronic circuit. The electronic circuit includes a power source, a load, a control circuit, and a relay. The relay includes an interface circuit, a magnetic core, and an output transistor. The interface circuit has a plurality of input terminals, a voltage supply terminal, and at least one output terminal. The plurality of input terminals are connected to the control circuit, and the voltage supply terminal is connected to the power source. The magnetic core is connected to the interface circuit and configured to form at least one bit of non-volatile core memory. The output transistor has a plurality of conduction terminals and a control terminal. The control terminal is connected to the output terminal of the interface circuit. One of the conduction terminals is connected to the power source, and another one of the conduction terminals is connected to the load. The output transistor is configured to switch the load.

These and other aspects of the invention will become apparent from the following disclosure.

### BRIEF DESCRIPTION OF THE DRAWINGS

FIG. 1 shows a schematic diagram of a circuit including a relay according to a preferred embodiment of the invention.

FIG. 2 is a more detailed schematic diagram of the relay shown in FIG. 1.

FIG. 3 is a schematic diagram of a driver circuit of an electrical interface circuit according to a preferred embodiment of the invention.

FIG. 4 is a schematic diagram of an electromagnetic non-volatile state retention circuit according to a preferred embodiment of the invention.

FIG. 5 is a schematic diagram of a detection circuit of the electrical interface circuit according to a preferred embodiment of the invention.

### DETAILED DESCRIPTION OF THE PREFERRED EMBODIMENTS

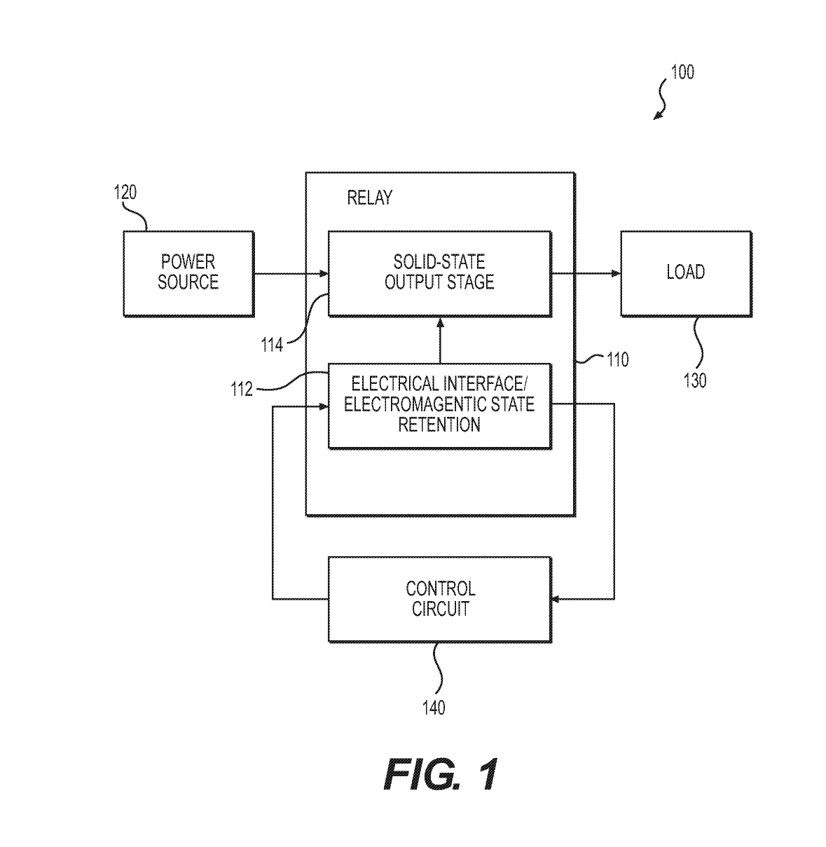

FIG. 1 shows a circuit 100 including a relay 110 according to a preferred embodiment of the invention. The relay 110 is used to control or supply power from a power source 120 to a load 130. The relay 110 may be used in various applications, such as space applications, including satellites and the like. In a satellite, for example, the power source 120 may include the primary satellite bus voltage and the load 130 may include the electronics onboard the satellite. The application, such as the satellite, includes a control circuit 140 that is coupled to the relay 110, which, in turn, is used to control or supply power to the load 130. The relay 110 includes an electrical interface with electromagnetic non-volatile state retention 112, which is connected to a solid-state output stage 114.

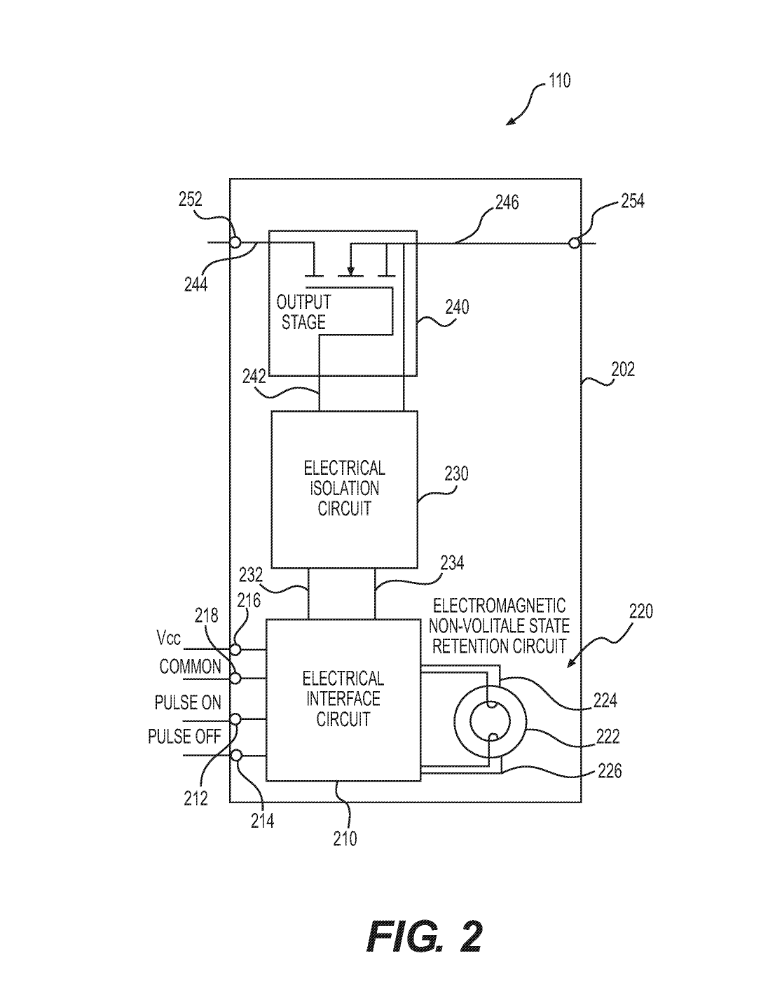

FIG. 2 shows the relay 110 in more detail. The relay 110 includes a housing 202 that houses an electrical interface circuit 210, an electromagnetic non-volatile state retention circuit 220, an electrical isolation circuit 230, and an output transistor 240. Together, the electrical interface circuit 210 and the electromagnetic non-volatile state retention circuit 220 are an exemplary embodiment of the electrical interface 112 (see FIG. 1), and together, the electrical isolation circuit 230 and the output transistor 240 are an exemplary embodiment of the solid-state output stage 114 (see FIG. 1). The electrical interface circuit 210 is controlled by two input terminals 212, 214, such as the coil inputs used in a typical electromechanical latching relay. The power to this circuit will be provided by two other terminals 216, 218. In this embodiment, the power is supplied to the power supply terminals 216, 218 of the electrical interface circuit 210 by the power source 120 (see FIG. 1).

In this embodiment, the output transistor 240 is an output field effect transistor (FET) having a gate (or control terminal) 242. The output FET 240 also has a source terminal 244 and a drain terminal 246 (both conduction terminals) connected, respectively, to output terminals 252, 254 of the relay 110. The first output terminal 252 is connected to a voltage supply (power source 120 in FIG. 1), while the second output terminal 254 is connected to the load 130 (see FIG. 1). In this embodiment, power is supplied to the control terminal (gate) 242 of the output FET 240 to turn on the output FET 240 and electrically connect the power source 120 to the load 130 (see FIG. 1). The state of the output FET 240 may be referred to as the latched state. In this embodiment, for example, when the output FET 240 electrically connects the power source 120 to the load 130 the output FET 240 is in the “on” latched state. The output FET 240 may be a high power device that can control relatively large currents, which would otherwise damage or shorten the life if typical electromechanical latching relay contacts were used. Another advantage of the solid-state output stage 114/output FET 240 is that the turn-on and turn-off times can be controlled, avoiding fast transients that could damage the load 130. A person of ordinary skill in the art will recognize that other suitable semiconductor output switching devices and other suitable arrangements of the output FET 240 may be used without deviating from the scope of the invention. Other suitable arrangements include, for example, multiple pole applications such as Double Pole Double Throw (DPST) and multiple throw applications such as Single Pole Double Throw (SPDT). In these alternative arrangements, multiple output FETs 240 may be used to comprise the solid-state output stage 114. Moreover, the output FET 240 may be arranged in a high or low side configuration without deviating from the scope of the invention.

The electrical isolation circuit 230 is connected between the electrical interface circuit 210 and the control terminal 242 of the output FET 240. The electrical isolation circuit 230 provides isolated voltage to control the output FET 240. The electrical isolation circuit 230 also adds protection to the electrical interface circuit 210 and subsequently connected devices in the event that the solid-state output stage 114 fails. The electrical isolation circuit 230 receives power and control signals from at least one output terminal 232, 324 of the electrical interface circuit 210. Any suitable electrical isolation circuit 230 may be used including, for example, a photovoltaic device, such as the PhotoVoltaic Isolator from International Rectifier of El Segundo, Calif., or a magnetic transformer coupling device, such as the device described in U.S. Pat. No. 3,522,509. In other embodiments, the electrical isolation circuit 230 may not be needed or other circuits may be used, including, for example, a separate isolated voltage source or a level shifter.

A small control signal is input through input terminals 212, 214 from the control circuit 140 (see FIG. 1) and may be selectively applied to the electrical interface circuit 210 to control the electrical isolation circuit 230, which, in turn, controls the output FET 240. A state retention function is provided by the electromagnetic non-volatile state retention circuit 220. The electromagnetic non-volatile state retention circuit 220 includes a solid-state memory device configured to form one bit of non-volatile memory. In this embodiment, the electromagnetic non-volatile state retention circuit 220 includes a magnetic core 222, a first (input) winding 224 wrapped around the magnetic core 222, and a second (output) winding 226 wrapped around the core 222, forming the basis for one bit of magnetic core memory. Herein the electromagnetic non-volatile state retention circuit 220 may also be referred to as the electromagnetic core memory 220.

The magnetic core 222 is a ring of a magnetic material. When current is passed through the input winding 224 in a first direction, the magnetic core 222 is polarized in a first direction, which corresponds to a binary state. For example, the magnetic core 222 may store a binary “1” when it is polarized in the positive direction. When current is passed through the input winding 224 in a second direction, opposite to the first direction, the magnetization of the magnetic core 222 can be reversed and polarized in the negative direction to store a binary “0.” The magnetic core 222 may be made from any suitable magnetic material including, for example, the materials disclosed in U.S. Pat. Nos. 2,950,251; 2,981,690; and 3, 3039,966, the disclosures of which are incorporated herein in their entirety. As discussed in these patents, the magnetic material is preferably material having a square hysteresis loop. In this embodiment, the input winding 224 has a single turn used to magnetize the magnetic core 222, but any suitable number of windings may be used. Likewise, the output winding 226 has a single turn in this embodiment, but any suitable number of turns may be used.

The electrical interface circuit 210 includes a driver circuit 300. The driver circuit 300 will react to either the “on” pulse signal through terminal 212 or the “off” pulse signal through terminal 214 and store the appropriate latched state in the magnetic core 222. The driver circuit 300 stores the state as the electrical interface circuit 210 applies the appropriate signals to the electrical isolation circuit 230 to command the output FET 240 to either the on state or the off state.

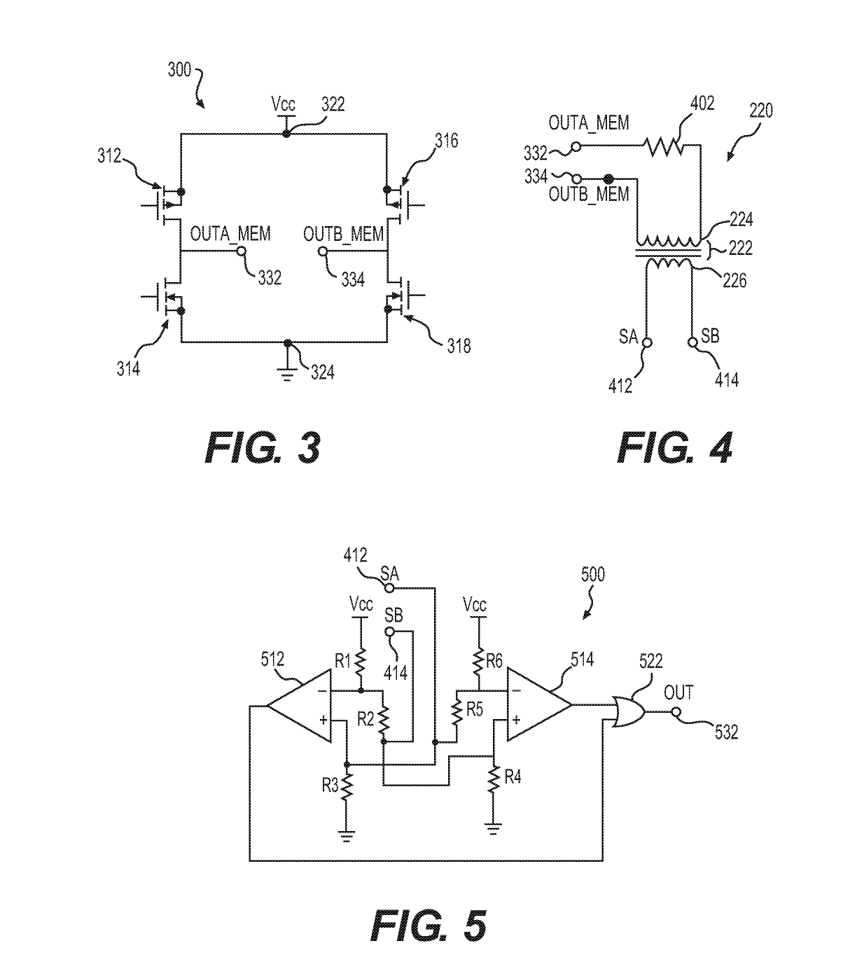

A schematic diagram of the driver circuit 300 according to a preferred embodiment of the invention is shown in FIG. 3, but any suitable driver circuit may be used. A schematic diagram of the electromagnetic non-volatile state retention circuit 220 according to a preferred embodiment of the invention is shown in FIG. 4. The driver circuit 300 includes four transistors: a first transistor 312, a second transistor 314, a third transistor 316, and a fourth transistor 318, arranged as an H bridge. In this embodiment, the first and third transistors 312, 316 are p-type FETs, and the second and fourth transistors 314, 318 are n-type FETs. A voltage is applied to the driver circuit 300 through terminal 322 from the power supply terminal 216, and the driver circuit is connected to the common power supply terminal 218 through terminal 324.

When the “on” current pulse is provided through input terminal 212, the first and fourth transistors 312, 318 are turned on allowing current to flow out a first terminal 332 (OutA_Mem), through the input winding 224 of the electromagnetic core memory 220, and back into the driver circuit 300 through a second terminal 334 (OutB_Mem). As a result, the magnetic core 222 is polarized in the positive direction to store the binary digit 1, representing the “on” state of the relay 110. Because the magnetic core 222 preferably has a square hysteresis loop, the residual flux density of the magnetic core 222 will remain near the saturation flux density after the current through the input winding 224 is removed. Likewise, when the “off” current pulse is provided through input terminal 214, the second and third transistors 314, 316 are turned on allowing a reverse flow through the input winding 224, with current flowing out the second terminal 334 (OutB_Mem) and into the driver circuit 300 through the first terminal 332 (OutA_Mem). As a result, the magnetization direction of the magnetic core 222 is reversed to the negative direction, storing the binary digit 0. Thus, the non-volatile state retention function is being performed through the magnetic core 222. The direction of current flow through the input winding 224 to magnetize the magnetic core 222 in the negative direction is referred to as dot current, and the direction of current flow through the input winding 224 to magnetize the magnetic core 222 in the positive direction is referred to as non-dot current.

In this embodiment, the magnetic core 222 has an inductance from about 50 nH to about 100 nH. When each of the first, second, third, and fourth transistors 312, 314, 316, 318 are turned on in their respective pairs, they may be turned on for about 2 μs with a fixed amount of current flowing through the driver circuit 300 and the electromagnetic core memory 220. The amount of current may be determined by the RDS(on) for each of the first, second, third, and fourth transistors 312, 314, 316, 318 and the equivalent series resistance of the magnetic core 222 and input winding 224. The current may be further regulated by including a current limiting resistor 402 in the electromagnetic non-volatile state retention circuit 220.

The magnetic core 222 provides the non-volatile state retention for the relay 110, so that if power is removed or lost, the relay 110 will still remain in its prior latched state when power is restored. When power is restored, the electrical interface circuit 210 reads what state had previously been stored in the magnetic core 222. The electrical interface circuit 210 includes a detection circuit 500 to determine the polarization state of the magnetic core 222 and to provide a memory reading function that is used to return the output FET 240 to its desired prior state. An example detection circuit 500 is shown in FIG. 5, but any suitable detection circuit may be used.

The detection circuit 500 is connected to the output winding 226 of the electromagnetic core memory 220 through a first sense line (SA) 412 and a second sense line (SB) 414. The detection circuit 500 shown in FIG. 5 is configured to detect an input from either the first sense line (SA) 412 or a second sense line (SB) 414. The detection circuit 500 includes a first comparator 512 and a second comparator 514. The output of each comparator 512, 514 is connected to an OR gate 522. The dual comparator 512, 514 arrangement allows the detection circuit 500 to respond to an input from either sense line (SA or SB) 412, 414, to cause one comparator 512, 514 to go to a high state, subsequently triggering the OR function of the OR gate 522 and outputting a high voltage from the detection circuit 500 output 532.

Preferably, the detection circuit 500 is designed to detect an input that is greater than a minimum voltage threshold in order to provide noise immunity and allow for adequate voltage amplitude detection upon reversal of the changing magnetic field of the magnetic core 222. In this embodiment, the minimum voltage threshold is set at ±20 mV. As shown in FIG. 5, the resistor divider networks of the detection circuit 500 are configured such that the comparator's inverting input is above the non-inverting input by 20 mV. The input voltages for the first and second comparators can be calculated using the following equations:

$$\begin{matrix}First Comparator 512 {(}^{″} {+}^{″} input ) = Vcc * \frac{\frac{R 3 * R 4}{R 3 + R 4}}{\frac{R 3 * R 4}{R 3 + R 4} + \frac{( R 1 + R 2 ) * ( R 5 + R 6 )}{R 1 + R 2 + R 5 + R 6}} + \frac{\frac{{V}_{SA - SB}}{R 1 + R 2} + \frac{{V}_{SA - SB}}{R 4}}{\frac{1}{R 1 + R 2} + \frac{1}{R 5 + R 6} + \frac{1}{R 3} + \frac{1}{R 4}} & Equation ( 1 ) \\ First Comparator 512 {(}^{″} {-}^{″} input ) = \frac{Vcc - \frac{Vcc * \frac{R 3 * R 4}{R 3 + R 4}}{\frac{R 3 * R 4}{R 3 + R 4} + \frac{( R 5 + R 6 ) * ( R 1 + R 2 )}{R 1 + R 2 + R 5 + R 6}}}{R 1 + R 2} * R 2 + \frac{Vcc * \frac{R 3 * R 4}{R 3 + R 4}}{\frac{R 3 * R 4}{R 3 + R 4} + \frac{( R 5 + R 6 ) * ( R 1 + R 2 )}{R 1 + R 2 + R 5 + R 6}} - \frac{\frac{{V}_{SA - SB}}{R 5 + R 6} + \frac{{V}_{SA - SB}}{R 3}}{\frac{1}{R 1 + R 2} + \frac{1}{R 5 + R 6} + \frac{1}{R 3} + \frac{1}{R 4}} & Equation ( 2 ) \\ Second Comparator 514 {(}^{″} {+}^{″} input ) = Vcc * \frac{\frac{R 3 * R 4}{R 3 + R 4}}{\frac{R 3 * R 4}{R 3 + R 4} + \frac{( R 1 + R 2 ) * ( R 5 + R 6 )}{R 1 + R 2 + R 5 + R 6}} - \frac{\frac{{V}_{SA - SB}}{R 5 + R 6} + \frac{{V}_{SA - SB}}{R 3}}{\frac{1}{R 1 + R 2} + \frac{1}{R 5 + R 6} + \frac{1}{R 3} + \frac{1}{R 4}} & Equation ( 3 ) \\ Second Comparator 514 {(}^{″} {-}^{″} input ) = \frac{Vcc - \frac{Vcc * \frac{R 3 * R 4}{R 3 + R 4}}{\frac{R 3 * R 4}{R 3 + R 4} + \frac{( R 5 + R 6 ) * ( R 1 + R 2 )}{R 1 + R 2 + R 5 + R 6}}}{R 6 + R 5} * R 5 + \frac{Vcc * \frac{R 3 * R 4}{R 3 + R 4}}{\frac{R 3 * R 4}{R 3 + R 4} + \frac{( R 5 + R 6 ) * ( R 1 + R 2 )}{R 1 + R 2 + R 5 + R 6}} + \frac{\frac{{V}_{SA - SB}}{R 1 + R 2} + \frac{{V}_{SA - SB}}{R 4}}{\frac{1}{R 1 + R 2} + \frac{1}{R 5 + R 6} + \frac{1}{R 3} + \frac{1}{R 4}} & Equation ( 4 )\end{matrix}$$

where, Vcc is the supplied voltage; V_{SA-SB} is the voltage differential between the first sense line (SA) 412 and the second sense line (SB) 414; and R₁, R₂, R₃, R₄, R₅, and R₆ are the resistance values of the corresponding resistors shown in FIG. 5. Preferably (but not necessarily), the circuit is symmetrical, for example where R₁=R₆, R₂=R₅, and R₃=R₄. In which case, each of the first and second comparator 512, 514 outputs are shifted to a high state when the comparator inputs are equal to a direct current offset plus the differential magnitude between the first sense line (SA) 412 and the second sense line (SB) 414.

When a pulse greater than 20 mV is sensed on either the first sense line (SA) 412 or the second sense line (SB) 414, one of the comparators 512, 514 will trip and go to a high state. Otherwise, the comparators 512, 514 will remain at a low state. In the arrangement shown in FIG. 5, the first comparator 512 will trip if a positive sense pulse occurs in which the first sense line (SA) 412 rises more than 20 mV above the second sense line (SB) 414. Conversely, the second comparator will trip if the second sense line (SB) 414 rises 20 mV more than the first sense line (SA) 412.

The electrical interface circuit 210 also includes startup logic and circuitry. Upon startup of the relay 110, the electrical interface circuit 210 will perform a read memory operation and a memory refresh operation. Any suitable device may be used to accomplish the functionality and operations of reading the electromagnetic core memory 220, refreshing the electromagnetic core memory 220, and returning the output FET 240 to the prior latched state. Several topologies that may be used for the startup logic include, for example, a mixed signal application specific integrated circuit (ASIC) and a programmable logic device such, as a microcontroller or field-programmable gate array (FPGA).

In this embodiment, the startup logic and detection circuit 500 are configured to perform the read operation by sending dot current through the input winding 224 of the electromagnetic core memory 220. Thus, upon startup, the electrical interface circuit 210 will turn on the second and third transistors 314, 316 (like when the “off” pulse is received) for about 2 μs. If the magnetic core 222 is already polarized in the negative direction (0 state), no change in the magnetization of the magnetic core 222 will be induced. Consequently, the detection circuit 500 will not detect an input of 20 mV or greater from either the first and second sense lines (SA or SB) 412, 414, and the output 532 of the detection circuit 500 will remain low.

If, however, the magnetic core 222 is in the positive direction (1 state), the dot current flowing through input winding 224 will change the polarization of the magnetic core 222 from the positive direction to the negative direction. The changing magnetic field of the magnetic core 222 will induce a current in the output winding 226 of the electromagnetic core memory 220. The detection circuit 500 will then sense an input greater than 20 mV through one of the first and second sense lines (SA or SB) 412, 414 and output a voltage through output 532. This output voltage can then be used to trigger the electrical interface circuit 210 to supply voltage to the electrical isolation circuit 230, thus providing supply power to the control terminal 242 of the output FET 240 and returning the relay 110 to its on latched state after power is restored.

When the read operation is performed to extract the stored state of 1, it is a destructive operation in that the magnetic core 222 is now polarized in the negative direction, storing a state of 0 instead of 1. The electrical interface circuit 210 thus performs a refresh operation on the electromagnetic core memory 220 by turning on the first and fourth transistors 312, 318 and sending non-dot current through the input winding 224 to polarize the magnetic core 222 in the positive direction, thus, storing a state of 1. If the output voltage from the detection circuit 500 (from output 532) is configured to trigger the “on” pulse signal through terminal 212, the output FET 240 may be returned to its prior latched state and the refresh operation may be accomplished, as described above when the “on” pulse signal is received from the control circuit 140 through terminal 212.

There are many advantages of the relay 110 described herein. One advantage of the electromagnetic core memory 220, is that it is suitable for reliable use in harsh shock and vibration environments. The electromagnetic core memory 220 is also suitable for use in radiation environments because its state retention function does not degrade from radiation exposure, such as cumulative ionizing radiation dose effects and single event effects. In addition, the electrical interface circuit 210, electromagnetic core memory 220, and solid-state output stage 114 can be relatively small. As a result, the components of relay 110 can be arranged in such a manner within the housing 202 to have a relatively small footprint and form a high-density circuit arrangement.

The embodiments discussed herein are examples of preferred embodiments of the present invention and are provided for illustrative purposes only. They are not intended to limit the scope of the invention. Although specific configurations, structures, materials, etc. have been shown and described, such are not limiting. Modifications and variations are contemplated within the scope of the invention, which is to be limited only by the scope of the issued claims.

What is claimed is:

1. A relay comprising:
an interface circuit including a plurality of input terminals, a voltage supply terminal, and at least one output terminal;
a magnetic core connected to the interface circuit and configured to form at least one bit of non-volatile core memory; and
an output transistor including a plurality of conduction terminals and a control terminal, the control terminal being connected to the output terminal of the interface circuit.

2. The relay of claim 1, further comprising an electrical isolation circuit connected between the interface circuit and the output transistor, the electrical isolation circuit being connected to the output terminal of the interface circuit and the control terminal of the output transistor.

3. The relay of claim 1, wherein the interface circuit is configured to polarize the magnetic core in a first direction when a pulse input signal is received on one of the input terminals.

4. The relay of claim 3, wherein the interface circuit is configured to polarize the magnetic core in a second direction when a pulse input signal is received on another one of the input terminals.

5. The relay of claim 4, wherein the interface circuit is configured to read the direction of polarization of the magnetic core.

6. The relay of claim 5, wherein the interface circuit is configured to turn on or turn off the output transistor based on the direction of polarization read.

7. The relay of claim 1, further comprising an input winding wrapped around the magnetic core, wherein the interface circuit is configured to send current through the input winding in a first direction to polarize the magnetic core in a first direction when a pulse input signal is received on one of the input terminals.

8. The relay of claim 7, wherein the interface circuit is configured to send current through the input winding in a second direction to polarize the magnetic core in a second direction.

9. The relay of claim 8, wherein the interface circuit is configured to send the current through the input winding in the second direction when a pulse input signal is received on another one of the input terminals.

10. The relay of claim 8, further comprising an output winding wrapped around the magnetic core, wherein, if the magnetic core is polarized in the first direction when the interface circuit sends the current through the input winding in the second direction, the interface circuit is configured to turn on the output transistor in response to the current induced in the output winding.

11. The relay of claim 8, wherein the interface circuit is configured to send the current through the input winding in the second direction upon startup of the relay.

12. The relay of claim 1, wherein the output transistor includes at least one field-effect transistor.

13. The relay of claim 1, further comprising a housing, the housing at least partially enclosing the interface circuit and the magnetic core.

14. The relay of claim 8, wherein the housing at least partially encloses the output transistor.

15. An electronic circuit comprising:
a power source;
a load;
a control circuit; and
a relay, the relay including:
an interface circuit having a plurality of input terminals, a voltage supply terminal, and at least one output terminal, the plurality of input terminals being connected to the control circuit, and the voltage supply terminal being connected to the power source;
a magnetic core connected to the interface circuit and configured to form at least one bit of non-volatile core memory; and
an output transistor having a plurality of conduction terminals and a control terminal, the control terminal being connected to the output terminal of the interface circuit, with one of the conduction terminals being connected to the power source, another one of the conduction terminals being connected to the load, wherein the output transistor is configured to switch the load.

16. The electronic circuit of claim 15, wherein the control circuit is configured to supply an input pulse signal to one of the plurality of input terminals of the interface circuit.

17. The electronic circuit of claim 16, wherein the interface circuit is configured to polarize the magnetic core in a first direction when the interface circuit receives the input pulse signal.

18. The electronic circuit of claim 17, wherein:
the input pulse signal received by the one of the plurality of input terminals is a first input pulse signal, and
the control circuit is configured to supply a second input pulse signal to another one of the plurality of input terminals of the interface circuit, the interface circuit being configured to polarize the magnetic core in a second direction when the interface circuit receives the second input pulse signal.

19. The electronic circuit of claim 18, wherein:
the interface circuit is configured to read the direction of polarization of the magnetic core, and
the output transistor is configured to switch the load based on the direction of polarization of the magnetic core read by the interface circuit.

20. A relay comprising:
an interface circuit including a plurality of input terminals, a voltage supply terminal, and at least one output terminal;
a solid-state memory device connected to the interface circuit and configured to form one bit of non-volatile memory; and
an output transistor including a plurality of conduction terminals and a control terminal, the control terminal being connected to the output terminal of the interface circuit.
